(19) United States
(12) Patent Application Publication
(10) Pub. No.: US 2004/0180184 A1
(43) Pub. Date: Sep. 16, 2004

(54) Coated paper and process for producing same

(76) Inventors: Mario Fillion, Quebec (CA); Denis Chabot, Quebec (CA); Gilles Bouchard, Quebec (CA)

Correspondence Address: OGILVY RENAULT, 1981 MCGILL COLLEGE AVENUE, SUITE 1600, MONTREAL, QC, H3A2Y3, CA

(21) Appl. No.: 10/476,481

(22) PCT Filed: Dec. 23, 2002
(86) PCT No.: PCT/CA02/02027

(30) Foreign Application Priority Data
Mar. 18, 2002 (CA) 2,377,775

(51) Int. Cl. B32B 3/00

(52) U.S. Cl. 428/211.1

(57) ABSTRACT

In the conventional process of producing a coated paper, the use of a furnish that is characterized by a base sheet fiber content made of about 60 to 85 weight percent of a bleached thermomechanical pulp (TMP), about 10 to 35 weight percent of a bleached chemical pulp and 0 to about 15 weight percent of a deinked pulp, and also comprising about 12 to 20 weight percent of an inorganic filler, with a freeness below 50 ml Csf and a brightness over 75° ISO, gives a coated paper of the same or superior quality and at a much lower cost than the usual coated paper obtained through a conventional process.

### TECHNICAL FIELD

The present invention relates to a coated printing paper, made predominantly from bleached thermomechanical pulp, that has high gloss, brightness, and opacity that is comparable or superior to coated papers that are produced primarily from chemical pulp, and a process for manufacturing same. More particularly, the invention is concerned with the provision of a paper furnish based on bleached thermomechanical pulp that is used to produce a coated paper of good quality and at a reasonable cost.

### BACKGROUND ART

Printing papers are produced in a number of grades, either coated or uncoated, dictated by the end use for the paper. The important appearance properties are opacity (see through), brightness (how reflective the paper is at a particular wavelength, typically 457 nm), and gloss. As opacity, brightness, and gloss increase, the quality (and price) of the paper increases. Newsprint and directory papers typically have the lowest brightness and negligible gloss whereas a Number 1 publication grade (for say a glossy annual report) would have the highest brightness and gloss. Table 1 herein below presents the range of values for some typical printing grades. In the table % Mech and % Chem refer to the percentage of mechanical pulp and chemical pulp, respectively, in the papermaking furnish. The letters SC stand for supercalendered in grades C, B, or A, the latter differing by the amount of filler present. C5 stands for coated paper grade 5, etc., and LWC stands for lightweight coated. (The terminology, C1-C5, is generally used in North America, whereas LWC is used elsewhere). See John D. Peel, “Paper Science and Paper Manufacture”. Angus Wilde Publications Inc., Vancouver, 1999.

TABLE 1
Some printing grades

| | Furnish | | | | | | Smoothness |
|---|---|---|---|---|---|---|---|
| | % Mech., | | Grammage | Brightness | Opacity | Gloss | PPS = 10S |
| | % Chem | Filler % | g/m² | ° ISO | % TAPPI | % Hunter | μm |
| Newsprint | 70-100, 30-0 | 0-16 | 40-48.8 | 57-60 | 90-94 | — | 2.6-4.2 |
| Catalogs | | | | | | | |
| SCC | 30-80, 70-20 | 0-7 | 45-90 | 65-85 | 85-92 | 25 | 1.7-2.6 |
| SCB | 30-80, 70-20 | 7-15 | 45-60 | 65-85 | 85-92 | 35 | 1.5-1.9 |
| SCA | 30-80, 70-20 | 16-30 | 45-60 | 65-85 | 85-92 | 46- | 1.1-1.4 |
| Coated Papers | | | | | | | |
| C5(LWC) | 45-70, 55-30 | 4-15 | 42-80 | 68-75 | 85-92 | 50-58 | 0.9-1.9 |
| C4 | 50, 50 | 4-12 | 50-70 | 72-78 | 90-94 | 60-65 | 1.3-1.6 |
| Invention | 65-85, 15-35 | 10-20 | 50-82 | 75-84 | >90 | 60-75 | 0.9-1.5 |
| C3 | 0-10, 100-90 | 10-20 | 75-150 | 76-82 | 90-95 | 63-72 | 0.8-1.4 |
| C2 | 0, 100 | ˜20 | | 78-82 | 95-98 | to 80 | 0.8-1.4 |
| C1 | 0, 100 | ˜20 | | 83-88 | 95-98 | to 90 | 0.8-1.4 |

Brightness, as defined in the paper industry, is the reflectivity of the paper at a particular wavelength, typically 457 nm. The reflectivity, in turn, is the ability of the paper to scatter light from the air-fiber or air-pigment interfaces within the paper web, usually defined in terms of a light scattering coefficient. A “white” paper is one that would equally reflect or scatter all the wavelengths in the visible spectrum, and not absorb any wavelengths. Thus paper brightness is achieved by bleaching the pulp to remove chromophores that may absorb light at some wavelength, adding more fiber to create more air-fiber interfaces, and/or adding high brightness fillers that scatter the light at all wavelengths in the visible part of the spectrum. Many people take brightness to be the “whiteness” of the paper, and while this is not technically correct, higher brightness is generally perceived as better quality.

Gloss is the ability to reflect light at a particular, specular angle and higher gloss is generally related to higher quality. Gloss is thus an indicator of surface smoothness. Newsprint, which is not coated, may have a brightness of less than 62° ISO and a gloss of less than 12% Hunter, whereas a high quality coated printed grade (C1) will have a brightness greater than 87° ISO and a gloss exceeding 75%.

Opacity is the property of not being able to see through the paper. Paper that is not too thin appears opaque because, as noted above, light is scattered at the air-fiber interfaces and all of the light cannot pass through the sheet. In fact “printing opacity” is defined as the ratio of the reflectance for a given paper with a backing of zero reflectance to the reflectance of the same paper if it were infinitely thick. Opacity can be achieved by using mechanical pulps that contain a lot of “fines” or particulate material that increase the surface area available for light scattering, by increasing the amount of fiber, by minimizing refining of the chemical pulp(s), by adding inorganic filler materials that will scatter light, and avoiding densification of the paper web by wet pressing or calendering during manufacture. Depending on the grade quality, however, not all of the above ways to control brightness, opacity, or gloss can be used: Often, an action made to enhance one paper property is detrimental to one of the other sheet properties. For example, calendering a paper made from chemical pulps to enhance gloss may decrease opacity due to the densification of the paper web. As with all engineered papers, there will be tradeoffs between raw materials and paper machine operating variables to produce a product with the desired convertibility or end use performance criteria. Occasionally, a new approach is discovered that creates a step change that allows one to produce a new superior product or the same quality product for much lower cost.

In North America there are five coated paper grades that are defined, with “coated #1”, or C1, being the highest total quality and cost (for example, a glossy annual report) and C5 the lowest quality and cost (for example, used in directories or catalogs). In this case, total quality includes the appearance properties (brightness, opacity, and gloss) as well as other desired attributes such as printability, tearing strength, internal bond strength, tensile strength or bending stiffness (see Table 1). Of the total coated paper market, the two largest segments in volume are C3 (for example, advertising inserts) at 31% and C5 at 41%. For comparison C1, C2, and C4 grades comprise 5%, 10%, and 13% of the market respectively. The difference in quality (and cost) for each of these grades is achieved by the use of different fiber types, pulping and/or bleaching methods, coating technology and type of calendering. For example, with reference to Table 1, the top three grades (C1-C3) are generally made from bleached chemical kraft pulps (less that 10% mechanical pulp) and are coated once, twice or even three times on each surface. These are often referred to as coated free (meaning no mechanical pulp is used) sheets, CFS. Grades C4 and C5 are primarily made from approximately equal blends of bleached groundwood and bleached chemical pulps and are referred to collectively as coated groundwood, CGW.

Because they are used in products that often go through the mail, the C4 and C5 grades are the lowest basis weight grades, and in this case there can be significant challenges in meeting brightness and gloss targets while maintaining opacity. Mechanical pulps are particularly suited for these grades because the fine or particulate material created during fiber separation and processing provides a large surface area and many air-fiber interfaces to scatter light. Accordingly, there are a variety of fiber types and manufacturing methods employed within each of the grades to achieve the desired appearance and other properties.

A layer of coating may be applied to the paper in a variety of ways. Each controls the amount of coating formulation (coating color) that is applied to the base paper to produce a uniform film, and the coater designs are classified according to how they meter the coating onto the paper. Transfer roll coaters use a sequence of rolls to produce a uniform film of coating similar to a gate roll size press, but these are not often used for pigmented coatings. Blade coaters, the most widely used, deposit an excess of coating formulation on the substrate and the excess is metered off with a trailing blade. There are a number of variations in blade coating technology. Rod coaters are similar to blade coaters except that a rotating wound wire or threaded rod is used to doctor the excess coating off the surface. Airknife coaters are also similar in that an excess of coating is applied but in this case the excess is doctored off by a jet of air leaving the desired amount of coating remaining on the paper. Airknife coaters are quite different from the other coater types in that the coating layer tends to uniform in thickness over the undulations in the surface rather than being thinner at the high spots in the paper. Film presses are used with pigmentized coatings to apply low coat weights (4-10 g/m² per side) at high speeds. Spray coaters may also be used in applying a coating.

A supercalender is built of a vertical stack of alternating resilient and non-resilient rolls with the paper passing sequentially through the nips defined by adjacent rolls. The non-resilient rolls are typically highly polished, smooth, steel rolls and the resilient rolls are typically cotton or polymer filled. During operation, the steel rolls are heated to some desired temperature and a load is applied to the top roll in the stack so that a pressure and high temperature is applied to the paper as it passes through each nip. In doing so, a gloss is imparted to the surface of the paper in each nip that is in contact with the smooth non-resilient roll. Supercalendering is performed to produce the desirable glossy surface on printing papers. The ability to achieve gloss depends upon the nature of the paper surface and base paper, the speed of operation of the supercalender, the temperature of the steel rolls and the applied pressure on the stack.

Supercalendering is normally carried out off line as a separate operation. Since the end of the 1990's, however, there has been a tendency to supercalender in-line whenever possible in order to lower costs. If it is possible to match the supercalender operating speed with the speed of the papermachine, while getting the same paper quality, one could expect some efficiencies since the paper would not have to be dried, wound up on a reel, and then moved to a different location in the mill for supercalendering. In addition, if the web needs to be re-moistened in some fashion prior to supercalendering to facilitate gloss development, as is often the case, there could be advantages by simply placing the supercalender right at the end of the papermachine and coater and eliminate the moistening step. Placing the supercalender in-line, however, will require careful control of the papermaking, coating, and supercalendering operations, because a problem in any one of these will stop the entire production in the mill. Thus, sophisticated process control measures are required to make this viable.

While the prior art generally discloses the production of C4 or C3 coated printing papers starting from a furnish having a fiber content of about 50 weight percent TMP and about 50 weight percent chemical pulp that also contains about 12 weight percent of inorganic filler, it does not describe nor suggest the possibility of using bleached thermomechanical pulp especially high levels thereof such as up to 80 weight percent TMP (fiber content), in such grades so as to produce C4 or C3 coated printing papers. It is speculated that such bleached thermomechanical pulps have not been used in such grades because of poor bonding (strength) properties, optical properties or, energy cost to meet quality requirements.

As used in the present specification and claims, the term bleached thermomechanical pulp is intended to mean a pulp having properties as defined in tables 2 and 3 hereinbelow. The thermomechanical pulp should also have a freeness below 50 ml Csf and a brightness over 75° ISO.

It is an object of the present invention to provide a coated paper of the same or superior quality and at a much lower cost than the usual coated paper of the prior art.

It is another object of the invention to provide a step change in the conventional process of producing a coated paper that allows to produce a new superior product or of the same quality at much lower cost.

It is another object of the present invention to provide a paper of similar quality in certain respects to typical coated papers that are made from 100% bleached kraft pulp, by using a paper furnish containing a bleached thermomechanical pulp.

### DISCLOSURE OF INVENTION

The above and other objects of the invention may be achieved by providing a process for producing a coated paper comprising the steps of:

a. providing a paper furnish;

b. forming the paper furnish into a consolidated web on a paper machine;

c. partially drying the consolidated web under conditions to form a base paper;

d. coating the base paper with using a film coating technology equipment;

e. drying the coated base paper; and

f. supercalendering the coated base paper;

characterized in that the said paper furnish has a sheet fiber content made of about 60 to 85 weight percent of a bleached thermomechanical pulp (TMP), about 10 to 35 weight percent of a bleached chemical pulp and, 0 to about 15 weight percent of a deinked pulp, said paper furnish also comprising about 12 to 20 weight percent of an inorganic filler, said bleached thermomechanical pulp having a freeness below 50 ml Csf and a brightness over 75° ISO.

The invention also relates to a coated paper of basis weight 50 to 82 g/m² containing a mixture of bleached thermomechanical pulp, bleached chemical pulp, optionally a deinked pulp, and an inorganic filler, in the percent ranges mentioned above, and having a PPS10-S smoothness less than 1.5 μm, preferably less than 1.3 μm, a TAPPI opacity exceeding 90%, a brightness exceeding 75° ISO and a Hunter gloss exceeding 65%, preferably 70%.

### Modes of Carrying Out the Invention

The preferred inorganic filler according to the invention may be ground calcium carbonate, precipitated calcium carbonate, calcined clay or the likes.

The bleached thermomechanical pulp preferably has a pulp brightness of about 80° ISO, a TAPPI opacity exceeding 90%, a scattering coefficient exceeding 49 m²/kg and, a light absorption coefficient less than about 1.2 m²/kg.

The present invention makes a significant advancement over the C4 and C3 grades shown in Table 1 in that it produces a sheet that is comparable or superior to a C4 coated grade and comparable to a C3 coated grade in the lower basis weight range, but preferably uses a significantly higher proportion of mechanical fiber in the form of a bleached thermomechanical pulp (TMP) concomitantly with significantly lower proportions of bleached chemical pulps. The preferred furnish composition is more closely aligned with a typical SC furnish, a supercalendered but uncoated grade. For example, for SC grades the furnish is typically between 30-80% mechanical pulp and 70-20% chemical pulp. For C4 grades the mechanical pulp would typically be 50% of the fibrous part of the furnish and the chemical pulp fraction 50%. For a higher quality C3 grade the ratio of mechanical to chemical pulp would typically be 10/90 or 0/100. In the present invention, with quality factors comparable to C3 grades, the preferred ratio of mechanical pulp to chemical pulp is 80/20. That can offer a considerable advantage in cost savings.

The bleached TMP is normally obtained from northern spruce and fir softwood material and optionally, from birch hardwood. The present invention preferably uses a thermomechanical pulp made from a blend of fir, spruce and potentially birch woods, all of which are readily reduced to fibrous form during pressurized refining and have good color and good strength. Average fiber length for either softwood species is around 3 mm with approximately 4 million fibers per gram. The average fiber length for birch would be around 1.5-1.8 mm with approximately 10 million fibers per gram. The thermomechanical pulp is preferably bleached with hydrogen peroxide to a brightnesss of ±80° ISO, for example between 75° and 85° ISO, preferably about 80°-81° ISO. In addition, to the elimination of the chromophores that cause color, hydrogen peroxide bleaching of the TMP also increases the number of carboxylic acid groups on the fiber surface by up to 100%, from, say, 95 to 200 mmol/kg (compared to 10-25 mmol/kg for a bleached sulfate chemical pulp). The increase in carboxylic acid groups, especially on the surface of the fibrous material, is known to enhance pulp strength properties (Zhang, Y. et al., J. Wood Chem. & Tech. 1994, 14(1); 83-102). Bleached thermomechanical pulp obtained by treatment with hydrogen peroxide also enables to reduce the specific light absorption coefficient to less than 1.2 m²/kg, and to increase the specific tensile strength of the pulp by 9 to 15%. For example, the bleached thermomechanical pulp may comprise about 60 to 75 weight percent balsam or eastern fir (Abies balsama) and about 40 to 25 weight percent Canadian spruce (Picea glauca), eastern spruce (Picea rubens), a black spruce (Picea mariana), any of which may be substituted with about 0 to 15 weight percent paper birch (Betula papyrifera) and/or yellow birch (Betula alleghaniensis) or any other members of the Betulaceae family. The bleached chemical pulp is preferably bleached chemical softwood.

According to the present invention, the preferred thermomechanical pulp has the following Bauer McNett fiber distribution:

| | |
|---|---|
| Mesh < 16 | 3-6% |
| Mesh 16-30 | 20-24% |
| Mesh 30-100 | 25-31% |
| Mesh 100-200 | 8-10% |
| Mesh > 200 | 33-38% |

thereby providing both high opacity and low porosity as well as high internal bonding to minimize blistering in the final coated paper.

The furnish can be formed into a web using a double wire, such as a SynFormer NP, forming device, or any other appropriate device. Preferably, the web is partially dried to a moisture content of less than 3.0% prior to pre-calendering and/or coating.

The consolidation of the base paper is preferably accomplished according to normal practice using a double wire forming section. The target basis weight in this case is around 34 to 54 g/m². After drying the web to the proper moisture content, the base paper is pre-calendered, if necessary, using a hard nip calender with steel rolls to provide a uniform thickness to the base paper as it passes into the in-line or off-line coater(s). The desired range of Bendtsen roughness is preferably from 200-250 ml/min.

Coating is normally carried out by spreading equally about 25 to 30 weight percent coating material over both sides of the base paper by using a single coating of about 6.5 to 10.0 g/m² on each side of the base paper. Alternately, coating may achieved by spreading equally about 25 to 40 weight percent coating over each sides of the base paper by using multiple coatings totaling about 6.5 to 17.0 g/m² on each side of the base paper. Although any suitable coating procedure may be used, according to the present invention, it is preferred use a film coater, such as a transfer roll coater, a film press, a rod coater, a spray coater or the likes.

Using an on-line or off-line film coater, a single film coating may be simultaneously applied to both sides of the base sheet or, with two such units providing two separate coating operations, two coatings may be applied to each side of the base sheet. Target coat weight is usually 6-16 g/m².

The coating formulation used herein is engineered to be compatible with the on-line or off-line calendering operation and can include any or all of GCC, clay, hollow sphere plastic pigments, glossing clay or binder.

The coated base paper is usually dried to a predetermined and controlled optimum moisture content to yield the optimal desired and end use performance. Preferably, the coated base paper is dried to a moisture content of about 7.5 to 8.5% prior to supercalendering.

Supercalendering of the coated paper base may be carried out on-line or off-line, and is normally achieved under conditions to produce a coated paper having a grammage of about 50 to 82 g/m² and a Hunter 75° gloss over 70%, an ISO brightness over 80° and a TAPPI opacity over 90%. The use of an on-line supercalender immediately following the coating dryers, rather than supercalendering off-machine in a separate operation, is advantageous from both a time and efficiency standpoint as noted earlier. It eliminates the handling of the paper web that would be required in an off-line supercalender operation and also allows the coated paper web moisture content to be controlled going into the supercalender, potentially minimizing the creation-of internal stresses that could cause other problems in the paper during printing or end use. One such problem that sometimes arises with the use of mechanical pulps (or coarse chemical pulp fibers) in coated papers is the ability of a pulp fiber that has been collapsed during supercalendering to snap back to its previously uncollapsed state when exposed to moisture and heat, e.g. during heatset offset printing. It is believed that mechanical pulp fibers in the coated base paper that pass directly into the supercalender at the proper moisture content will lose some or all of this propensity to regain their former uncollapsed state.

In the current invention, for manufacturing cost and quality considerations, it is preferred to place the supercalender in-line with the paper machine and coater, thus avoiding unnecessary handling of the paper and giving the papermaker a considerable amount of flexibility as to the moisture content of the paper as it enters the plurality of resilient and non-resilient rolls of the supercalender. It is believed that entering the nips at the proper moisture will help to stabilize collapsed fibers so that they are not prone to “pop open”, as is often the case, when they encounter a hot and moist environment at some later time, e.g. in heatset offset printing.

Supercalendering preferably immediately follows the drying step with roll temperatures of about 140-150° C. under an applied load of about 200 to 400 kN/m, under conditions to achieve a gloss of about 60 to 75% and a surface smoothness less than 1.5 μm PPS10, preferably less than 1.3 μm PPS10. Usually an eight to ten roll supercalender is used for this operation.

By virtue of the pulping method according to the invention, bleached thermomechanical provides a large amount of fines that can scatter light, and thus assist in achieving opacity and brightness.

According to the present invention, the inorganic filler, such as ground calcium carbonate, GCC, that is present in the papermaking furnish helps provide brightness, opacity, and gloss in the final product. This filler must have high brightness itself and be present in sufficient amounts to yield the desired effects, without disrupting bonding of the fibers in the base sheet. The desired range of high brightness filler in the papermaking furnish is 12 to 20% of the total furnish, as mentioned above.

The present invention uses high quality bleached thermomechanical pulps in the base paper, as opposed to the use of bleached chemical pulps, which are normally used in large quantities in C4 and C3 printed paper grades.

### EXAMPLES

The following is a detailed description of certain embodiments of the invention, given in the form of examples, deemed by the inventors to be the best manner of implementing the invention.

A major consideration in the implementation of the invention is the use of high quality and low cost bleached mechanical pulps in the base paper, as opposed to the use of bleached chemical pulps, which are normally used in C4 and C3 printed paper grades. In the present embodiment, a bleached thermomechanical pulp was used.

### Example 1

The wood species utilized and the preparation of the pulps is described here. Two separate blends were studied: a blend of 75% Balsam fir and 25% White spruce (75/25) and a blend of 70% Balsam fir, 20% White spruce and 10% White birch. For either blend the wood chips were preconditioned in water followed by three stages of pressurized refining using typical processing conditions and followed by screening, cleaning and rejects treatment. The pulps were then bleached using two-stage peroxide bleaching at typical conditions. Handsheets were prepared according to TAPPI standards using recirculated white water. Table 2 presents a summary of the pulp properties and Table 3 presents the paper properties for the two blends.

TABLE 2
Final pulp properties

| | | Unbleached pulps | | | Bleached pulps | | |
|---|---|---|---|---|---|---|---|
| | | Wood species: Balsam Fir/White Spruce/White Birch | | | | | |
| | | 70/20/10 | 75/25 | 75/25 | 70/20/10 | 75/25 | 75/25 |
| | | Screening/Cleaning | | | | | |
| Pulp properties | Units | S | S | S & C | S | S | S & C |
| Energy consumption | kWh/BDMT | 3963 | 3869 | 4005 | 3963 | 3869 | 4005 |
| Freeness CSF | Ml | 32 | 28 | 15 | 26 | 26 | 12 |
| Shives, Somerville 0.15 mm | % | 0.03 | 0.03 | 0.02 | 0.02 | 0.01 | 0.01 |
| Shives, PQM 1000 | % | 0.01 | 0.08 | 0 | 0.01 | 0.02 | 0.00 |
| Fiber length, PQM 1000 | mm | 1.23 | 1.27 | 1.2 | 1.21 | 1.25 | 1.22 |
| Bauer McNett, mesh | | | | | | | |
| >16 | % | 4.6 | 5.6 | 5.9 | 3.8 | 3.7 | 6 |
| 16-30 | % | 20 | 21.3 | 22 | 21.5 | 23.5 | 21.4 |
| 30-100 | % | 31 | 28.6 | 25.4 | 30.1 | 30.3 | 25.9 |
| 100-200 | % | 8.4 | 8.6 | 9.6 | 8.8 | 9.1 | 9.4 |
| <200 | % | 36 | 35.9 | 37.1 | 35.9 | 33.4 | 37.4 |
| ISO Brightness R457 | ° | 55.5 | 56.1 | 55.3 | 75.4 | 79.7 | 79.0 |

TABLE 3
Paper properties for final pulp

| | | Unbleached pulps | | | Bleached pulps | | |
|---|---|---|---|---|---|---|---|
| | | Wood species: Balsam Fir/White Spruce/White Birch | | | | | |
| | | 70/20/10 | 75/25 | 75/25 | 70/20/10 | 75/25 | 75/25 |
| | | Screening/Cleaning | | | | | |
| Paper properties | Units | S | S | S & C | S | S | S & C |
| Density | k/m³ | 534 | 562 | 615 | 612 | 637 | 684 |
| Tear index | mNm²/g | 5.42 | 5.23 | 4.66 | 5.04 | 4.50 | 4.60 |
| Burst index | kPam²/g | 2.84 | 3.27 | 3.55 | 3.07 | 3.32 | 3.60 |
| Tensile index | Nm/g | 52.6 | 56.5 | 58.7 | 54.5 | 63.8 | 66.3 |
| Roughness | ml/min | 85 | 51 | 26 | 49 | 54 | 28 |
| Porosity | ml/min | 20 | 14 | 8 | 12 | 52 | 5 |
| Scott bond | J/m² | 249 | 264 | 335 | 278 | 194 | 285 |
| Opacity (TAPPI) | % | 99.1 | 98.8 | 98.8 | 90.7 | 90.7 | 89.4 |
| Spec. light scattering coeff. | m²/kg | 63.6 | 60.9 | 61.8 | 52.3 | 51.6 | 49.0 |
| (S) | | | | | | | |
| Spec. light abs. coeff. (K) | m²/kg | 7.6 | 6.7 | 7 | 1.2 | 1.2 | 1.0 |

Referring to Table 2, we note that the fiber lengths for either blend are very similar, ranging from 1.2 to 1.3 mm for both the unbleached and bleached pulps. Table 2 also illustrates the effectiveness of the two-stage peroxide bleaching. The 70/20/10 blend brightness increases from 55.5 to 75.4, almost 20 points, while the 75/25 blend goes from 56.1 to 79.7 or 23.6 points. The screened and cleaned (S&C) 75/25 blend increased 23.7 points. Table 3 shows the impact of bleaching on tensile strength on the pulps. The tensile index of the 70/20/10, 75/25, and 75/25 S&C blends increase by 3.6%, 12.9%, and 12.9% respectively. This is indicative of the carboxylic acid groups created during peroxide bleaching as noted earlier. The peroxide bleaching not only removes the light absorbing chromophores (as evidenced by the specific light absorption coefficient, K, or the significant increase in brightness) but also significantly increases the tensile strength of the pulp. In fact, the tensile strength of the TMP described here is higher than most other mechanical pulps, including aspen pressure groundwood. This is a reason that less bleached chemical pulp will be required in the final base paper blend.

### Example 2

A first trial was conducted to demonstrate that the proposed concept was valid, namely that a high content bleached thermomechanical pulp could replace bleached chemical pulp in C4 and C3 grades, and that the coating and supercalendering operations could be carried out in-line with the papermachine. Two different papermaking furnishes were utilized in these trials. The first furnish, A, consisted of 59.0% bleached TMP, 26.6% bleached kraft (chemical) pulp and 14.4% GCC. The second furnish, B, consisted of 64.5% bleached TMP, 16.1% bleached kraft pulp and 19.4% GCC. In either case, the wood used for the bleached TMP was a blend of 75% Balsam fir and 25% White spruce.

The TMP was processed from newsprint cull rolls and the kraft purchased in the marketplace. The TMP pulp was separated and processed in four batches. The cull rolls were slushed and the pulp first refined at high consistency in an atmospheric Sunds Defibrator RG32/36 with plates 9811B to reduce CSF and shive content and increase pulp strength. The pulp was then screened in a 2-stage MUST screen with #0.10 mm slot baskets. The screen accepts were thickened to about 3% consistency and bleached using sodium hydrosulfite. Rejects were refined at high consistency in two stages, thickened and bleached as for the accepts. The reject line accepts and main line accepts were then combined. Three of the final TMP pulps had a CSF (freeness) of 35-36 ml, low shive content, length weighted fiber length L(I) of 1.3 mm, and tensile index, tear index, and ISO brightness of 55 Nm/g, 5.2-5.3 mNm²/g, and 77-78%, respectively. One batch of TMP was slightly lower in all properties having L(I), tensile index, tear index, and ISO brightness of 1.15 mm, 53 Nm/g, 4.9 mNm²/g, and 75°, respectively.

The bleached kraft chemical pulp was refined to a CSF of 320 (from 670) and had a tensile index and tear index of 95-101 Nm/g and 11.9-11.5 mNm²/g, respectively. The TMP and BKP were then blended into batches having TMP/BKP ratios of 70/30 or 80/20.

The filler was then added to the pulp batches in the percentages specified in the first paragraph of this example. The filler was Omya GCC with 95% ISO brightness and a Percol 47 retention aid system was used.

The base paper was produced at 800 m/min using a SymFlo headbox with short vanes and a SymFormer MB. The press section consisted of two straight through nips, the first a double felted shoe press and the second nip a single felted roll press with a transfer belt on the topside. The target basis weight was 43.6±1 g/m² (BD). In this pilot trial the rolls were shipped to another location to be dried.

Pre-calendering of the base paper was carried out with an OptiHard hard nip calender at load of 60 kN/m and 70° C. The smoother topside of the paper was calendered against the hot roll. The target Bendtsen roughness level was 200-250 ml/min, which was achieved with the specified loading. The caliper and ISO brightness of the “A” paper was 78 μm and 76.50°, respectively, and the “B” paper caliper and ISO brightness was 77 μm and 73.7°, respectively.

The two base papers were coated using an OptiSizer station, treating both sides of the paper simultaneously with 10 g/m². The top rod diameter was 12 mm with a hardness of 40P&G and the lower rod diameter was 15 mm with a hardness of 32 P&G. The nip pressure was 20 kN/m. The coating formulation is presented in Table 4.

TABLE 4
Coating formulation for the simulated on-line trials

| Material | Trade Name | Parts |
|---|---|---|
| CaCO3 | HC90 | 60 |
| Kaolin clay | Hydragloss | 40 |
| SB-latex | DL966 | 12 |
| CMC | FF10 | 0.3 |
| PVA | Moviol 6-98 | 0.5 |
| Stearate | Nopcote C | 0.8 |
| OBA | Blankophor P | 0.8 |

To achieve the trial target coat weight of 10 g/m² per side, the solids content was adjusted to 66% for the bottom beam and 65% for the top beam.

Supercalendering was done with an OptiLoad-8 at speeds of 1000-1200 m/min. Following a calibration procedure, the “A” coated paper was calendered at 145° C. (temperature of first 3 thermo rolls) with a linear load of 300 kN/m at 1000 m/min while the “B” paper was calendered at 140/145° C. with a load of 250 kN/m and speeds of either 1000 m/min or 1200 m/min. The first trial was conducted to demonstrate that it was possible to use a high thermomechanical pulp content, a concomitant low kraft content, a much higher filler content in the base sheet and to run the paper through a film coater. Table 5 presents a summary the results.

In summary, the simulated on-line trial showed that the use of bleached TMP together with the in-line concept could be utilized to produce a C4 grade with gloss, opacity, and ISO brightness exceeding 60°, 88°, and 78°, respectively. Final paper quality parameters were adjusted during the second set of trials by varying different settings.

### Example 3

Three separate trials were conducted to determine the paper gloss potential between different coating formulations with and without plastic pigments, and also to compare gloss potential with single and double film coating operations. Each trial was carried out at a different location. The base paper for trials one and two was a commercial SCA paper very similar to the preferred base paper described in Example 1. It had a high content of TMP, a high filler content, and a low kraft chemical pulp content. The paper had a basis weight of 49.2 g/m² and an ISO brightness of 73°. The SCA rolls were pre-calendered. The third trial used a commercial CGW base sheet that had a high content of bleached TMP but typical levels of chemical pulp and filler. The CGW base paper had a basis weight of 56.2 g/m² and an ISO brightness of 78°.

TABLE 5
Summary of the supercalendered paper trials

| | | | Recipe B |
|---|---|---|---|
| | | | 1200 m/ |
| | Recipe A | Recipe B | min |
| Hunter 75° gloss, ts/bs, [%] | 64.5/62.5 | 63.0/61.5 | 61.5/58.5 |
| PPS-s10 roughness, ts/bs, [μm] | 1.54/1.49 | 1.42/1.48 | 1.48/1.68 |
| End moisture, [%] | 4.3 | 4.0 | 4.3 |
| Cailper, [μm] | 58 | 60 | 60 |
| Density, [kg/m³] | 1185 | 1170 | 1160 |
| ISO brightness, [%] | 78 | 80 | 80.5 |
| D65 brightness, [%] | 81 | 83 | 84 |
| ISO opacity, [%] | 87.5 | 88.5 | 88.5 |
| Tensile strength MD/CD, | 4.2/1.15 | 4.25/1.1 | 4.3/1 |
| [kN/m] | | | |
| Tensile index MD/CD, [Nm/g] | 62.75/17.15 | 61.65/15.6 | 62.8/14.8 |
| Tear strength MD/CD, [mN] | 200/300 | 180/265 | 170/265 |
| Tear index MD/CD, [Nm²/kg] | 2.95/4.45 | 2.60/3.90 | 2.50/3.90 |
| Stretch MD/CD, [%] | 1.55/2.75 | 1.70/2.60 | 1.60/2.95 |
| Bending resistance, MD/CD, | 30.5/17.5 | 33.5/16.5 | 31/16 |
| [mN] | | | |
| Burst strength, [kPa] | 140 | 130 | 130 |
| IGT surface strength MD, ts, | 0.75 | 0.70 | 0.70 |
| [m/s] | | | |
| IGT surface strength CD, ts, | 0.55 | 0.50 | 0.50 |
| [m/s] | | | |
| IGT surface strength MD, bs, | 0.95 | 0.95 | 0.90 |
| [m/s] | | | |
| IGT surface strength CD, bs, | 0.55 | 0.60 | 0.60 |
| [m/s] | | | |

The first trial used a Beloit PMSP film coater running at 1190 m/min with either a single coating on both sides (1C2S) or two coatings on both sides (2C2S). The coating formulation was typical but included Omya GCC HC90 and Covercarb HP, Imerys Brazilian clays Capim DG, and a high content of glossing clay. Some formulations included hollow sphere plastic pigments HS3000NA.

The second trial utilized a Valmet OptiSizer MSP film coater at 1200 m/min also in 1C2S and 2C2S configurations. In this case the coating formulation included Omya GCC HC90 and Covercarb HP, Huber clays Hydragloss and Covergloss, and Dow latex. Again some formulations included HS3000NA hollow sphere plastic pigments.

The third trial used a Jagenberg FilmPress coater at 1200 m/min in 1C2S and 2C2S configurations. The coating formulation based on best current practices included the same GCC and clays utilized in trial one, solid sphere plastic pigments, and BASF latex and additives.

The coated papers from the three coating trials were supercalendered using an Optiload calender with a ten-roll configuration running at 1200 m/min. The linear loading and temperature calibrations determined in Example 2 with the same coating formulation were utilized. For the SCA base paper the loading was 200 kN/m and for the CGW base paper 250 kN/m was used. The coated papers were not remoistened and no steam showers were employed.

Summaries of the ranges of all of the results of the three trials are presented in Table 6. For the 1C2S samples the coat weights varied from 6.5 to 10 g/m² per side with a final paper basis weight range from 50.3 to 66.6 g/m² and for the 2C2S samples the coat weights were 12 to 17 g/m² per side with a final paper basis weight range from 66.6 to 81.4 g/m². These results demonstrate that by varying the appropriate parameters, the desired final quality targets of the present invention can be reached.

TABLE 6
Coating trial results

| | Trial 1 | Trial 2 | Trial 3 |
|---|---|---|---|
| Base sheet brightness, ° | 73.0 | 73.0 | 78.4 |
| Brightness after coating, ° | 79.0-80.6 | 79.8-81.5 | 86.1-87.8 |
| Brightness after calendering, ° | 74.3-75.9 | 76.0-79.0 | 83.8-85.5 |
| TAPPI opacity, % | 93.7-95.1 | 93.8-95.4 | 91.2-91.9 |
| Hunter 75° gloss, % | 66.6-77.6 | 60.2-70.6 | 53.5-65.7 |
| PPS 10-S smoothness, μm | 0.86-1.00 | 0.92-1.22 | 1.42-1.78 |

Considering that the base papers were coated either 1C2S or 2C2S with differing coat weights, and the coating formulations were varied within each trial, we can draw the following general conclusions.

PPS smoothness levels increase with higher chemical pulp content and lower filler levels in the base paper.

PPS smoothness levels around 1.0 μm can be achieved with a base paper containing high levels of bleached TMP and high levels of filler.

A 70% Hunter gloss can be achieved with a single coating on both sides with about 5 parts of hollow sphere plastic pigments and high glossing clay content.

A 75% Hunter gloss can be achieved with no or only a few parts of hollow sphere plastic pigments and high glossing clay content with a double film coating (2C2S).

It is understood that modifications are possible according to the invention, provided they fall within the scope of the appended claims.

1. A process for producing a coated paper comprising the steps of:
a. providing a paper furnish;
b. forming the paper furnish into a consolidated web on a paper machine;
c. partially drying the consolidated web under conditions to form a base paper;
d. coating the base paper using a film coating technology equipment;
e. drying the coated base paper; and
f. supercalendering the coated base paper;
characterized in that said paper furnish has a fiber content made of about 60 to 85 weight percent of a bleached thermomechanical pulp (TMP), about 10 to 35 weight percent of a bleached chemical pulp and 0 to about 15 weight percent of a deinked pulp, said paper furnish also comprising about 12 to 20 weight percent of an inorganic filler, said bleached thermomechanical pulp having a freeness below 50 ml Csf and a brightness over 75° ISO.

2. The process of claim 1, wherein the base paper is coated with a transfer roll coater, a rod coater, a film press, or a spray coater.

3. The process of claim 1, wherein said inorganic filler comprises ground calcium carbonate, precipitated calcium carbonate, or calcined clay.

4. The process of claim 1, wherein said calcium carbonate has a brightness exceeding 90% ISO.

5. The process of claim 4, wherein said brightness exceeds 95° ISO.

6. The process of claim 1, wherein said bleached TMP is obtained from northern spruce and fir softwood material, and optionally from birch hardwood.

7. The process of claim 1, wherein said TMP is bleached with hydrogen peroxide.

8. The process of claim 7, wherein said TMP is bleached to 75°-85° ISO brightness.

9. The process of claim 8, wherein said TMP is bleached to about 80°-81° ISO brightness.

10. The process of claim 1, which comprises drying said consolidated web under conditions to reach a grammage of about 34 to 54 g/m².

11. The process of claim 1 wherein previously to coating the base paper, the latter is pre-calendered on the paper machine so as to create a uniform thickness and smooth surfaces for surface coating.

12. The process of claim 1, wherein the base paper is coated on-line.

13. The process of claim 1, wherein the base paper is coated off-line.

14. The process of claims 1, 12 or 13, which comprises applying one coating on both sides of said consolidated web simultaneously.

15. The process of claims 1, 12 or 13, which comprises applying two successive coatings to each side of said consolidated web.

16. The process of claims 12 to 15, which comprises coating the base paper to a coat weight of about 6-17 g/m² on each said side.

17. The process of claim 1, which comprises supercalendering the coated base paper on-line.

18. The process of claim 1, which comprises supercalendering the coated base paper off-line.

19. The process of claims 17 or 18, which comprises supercalendering with an eight to ten roll supercalender.

20. The process of claims 17 or 18, wherein said supercalendering is carried out under conditions to produce a coated paper having a grammage of about 50 to 82 g/m².

21. The process of claim 18, wherein said supercalendering is adapted to achieve a Hunter 75° gloss over 70%, and with an ISO brightness over 80° and a TAPPI opacity over 90%.

22. The process of claim 1, wherein said bleached chemical pulp is bleached chemical softwood.

23. The process of claim 1, wherein said bleached thermomechanical pulp comprises about 60 to 75 weight percent balsam or eastern fir (Abies balsama) and about 40 to 25 weight percent Canadian spruce (Picea glauca), eastern spruce (Picea rubens), a black spruce (Picea mariana), any of which is substituted with about 0 to 15 weight percent paper birch (Betula papyrifera) and/or yellow birch (Betula alleghaniensis) or any other members of the Betulaceal family.

24. The process of claim 1, wherein said bleached thermomechanical pulp comprises about 60 to 75 weight percent Canadian spruce (Picea glauda), eastern spruce (Picea rubens), a black spruce (Picea mariana), and about 40 to 25 weight percent balsam or eastern fir (Abies balsama), any of which is substituted with about 0 to 15 weight percent paper birch (Betula papyrifera) and/or yellow birch (Betula alleghaniensis) or any other members of the Betulaceai family.

25. The process of claim 7, wherein said bleached TMP has a specific light scattering absorption coefficient less than about 1.2 m²/kg.

26. The process of claim 7, wherein said bleached TMP has a specific tensile strength increased by 9-15%.

27. The process of claim 1, wherein said consolidated web is formed by means of a double wire forming device.

28. The process of claims 1 or 11, wherein said consolidated web is dried to a moisture content of less than 3.0% prior to precalendering and/or coating.

29. The process of claim 11, wherein the partially dried base paper is pre-calendered on line under conditions to provide a uniform thickness with a surface Bendtsen roughness of about 200 to 250 ml/min.

30. The process of claim 13, which comprises spreading equally about 25 to 30 weight percent coating material over both sides of the base paper by using a single coating of about 6.5 to 10.0 g/m² on each side of the base paper.

31. The process of claim 15, which comprises spreading equally about 25 to 40 weight percent coating over each sides of the base paper by using multiple coatings totaling about 6.5 to 17.0 g/m² on each side of the base paper.

32. The process of claim 1, which comprises coating the base paper with a film coater.

33. The process of claim 17, which comprises drying the coated base paper to a moisture content of about 7.5 to 8.5% prior to supercalendering the coated paper.

34. The process of claims 17 or 18, which comprises supercalendering the coated base paper immediately following the drying step with roll temperatures of about 140°-150° C. under an applied load of about 200 to 400 kN/m, under conditions to achieve a gloss of about 60 to 75% and a surface smoothness less than 1.5 μm PPS10.

35. The process of claim 34, wherein said surface smoothness is less than 1.3 μm PPS10.

36. The process of claim 1, wherein said thermomechanical pulp has the following Bauer McNett fiber distribution:

| | |
|---|---|
| Mesh < 16 | 3-6% |
| Mesh 16-30 | 20-24% |
| Mesh 30-100 | 25-31% |
| Mesh 100-200 | 8-10% |
| Mesh > 200 | 33-38% |

thereby providing both high opacity and low porosity as well as high internal bonding to minimize blistering in the final coated paper.

37. A coated paper of basis weight 50 to 82 g/m² containing a mixture of bleached thermomechanical pulp, bleached chemical pulp and an inorganic filler, and having a PPS10-S smoothness less than 1.5 μm, a TAPPI opacity. exceeding 88%, a brightness exceeding 75° ISO and a Hunter gloss exceeding 65%, characterized in that it has a base sheet fiber content made of about 60 to 85 weight percent of a bleached thermomechanical pulp (TMP), about 10 to 35 weight percent of a bleached chemical pulp and 0 to about 15 weight percent of a deinked pulp, said base sheet paper also comprising about 12 to 20 weight percent of an inorganic filler, said bleached thermomechanical pulp having a freeness below 50 ml Csf.

38. The coated paper of claim 37, wherein said PPS10-S smoothness is less than 1.3 μm.

39. The coated paper of claim 37, wherein 60 to 85 weight percent of its fibrous material comprises a thermomechanical pulp produced from spruce, pine, or birch and 40 to 15 weight percent of its fibrous material comprises bleached chemical softwood pulp.

40. The coated paper of claims 37 or 39, comprising hydrogen peroxide bleached thermomechanical pulp and having a pulp brightness of about 80%, a TAPPI opacity exceeding 90%, a scattering coefficient exceeding 49 m²/kg and a light absorption coefficient less than about 1.2 m²/kg.

41. The coated paper of claim 40, having a density in the range 600 to 750 kg/m³, a tear index exceeding 4.5 mNm²/g, and a tensile index exceeding 54 Nm/g.

42. The coated paper of claim 41, wherein said tensile is about 65 Nm/g.

43. The coated paper of claims 37 to 42, wherein said inorganic filler comprises calcium carbonate, said coated paper having a brightness exceeding 90° ISO.

44. The coated paper of claim 43, wherein said brightness is about 95° ISO.

45. The coated paper of claims 37 to 43, having a single coating of 6.5 to 10 g/m² deposited on each side of the coated paper, that collectively vary from about 25.0 to 30.0 weight percent of the total composition of the coated paper.

46. The coated paper of claims 37 to 45, having multiple coatings of total masse per area of 6.5 to 17 g/m² deposited on each side of the coated paper that collectively vary from about 25.0 to 40.0 weight percent of the total composition of the coated paper.

47. The coated paper of claims 37 to 46, having surfaces producing a smoothness of less than 1.5 μm, and a Hunter gloss exceeding 65%.

48. The coated paper of claim 47, wherein said smoothness is less than 1.3 μm, and said Hunter gloss is higher than 70%.
